(19) United States
(12) Patent Application Publication
(10) Pub. No.: US 2018/0297045 A1
(43) Pub. Date: Oct. 18, 2018

(54) PLURAL COMPONENT MACHINE, HOSE AND SPRAY GUN SYSTEM

(71) Applicants: Thomas R. ELETTO, Saratoga Springs, NY (US); Timothy J. BECKER, Chicopee, MA (US); John C. BECKER IV, Monson, MA (US)

(72) Inventors: Thomas R. ELETTO, Saratoga Springs, NY (US); Timothy J. BECKER, Chicopee, MA (US); John C. BECKER IV, Monson, MA (US)

(21) Appl. No.: 15/953,740

(22) Filed: Apr. 16, 2018

Related U.S. Application Data
(60) Provisional application No. 62/485,538, filed on Apr. 14, 2017.

(51) Int. Cl. B05B 7/00; F16K 1/14; B05B 12/00

(52) U.S. Cl. CPC B05B 7/0025; B05B 12/002; F16K 1/14

(57) ABSTRACT

A pressurized fluid turbulence system includes a component inlet that receives a liquid component, component outlet for expelling the liquid component and an adjustable ball valve arranged between and in fluid communication with the component inlet and component outlet, and can open and close a flow path between the two. The component inlet and outlet both have a cylindrical channel and the component inlet is upstream from the component outlet. A cylindrically shaped pressurized input receives a pressurized fluid and has a longitudinal axis aligned in a direction towards the adjustable ball valve such that a pressurized fluid may impact the adjustable ball valve when the pressurized input is in an open position. A system for mixing two liquid components includes two pressurized fluid turbulence systems in which the two liquid components are mixed downstream of the component outlets.

### BACKGROUND

The application of highly reactive chemical compounds, including Spray Foam and high performance, high solids or 100% solids coatings is a delicate process that is susceptible to errors caused by both installer and/or machine, for many reasons.

Successful application relies on many factors, such as the correct formulation to yield a product with the specified properties required, application equipment that operates in accordance with its own specifications, provides the operating environment appropriate to the specific chemical formulation being applied, and produces consistent results of that chemical composition, and an installer properly trained for both how the chemical compound is supposed to work and correct operation of the application equipment selected.

Frequently, the operating environment that the application equipment provides creates issues of the volumetric ratio between the two components being mixed. In order to create a chemical compound through the application equipment that meets the specifications of the compound, proper mixing of the A-side and the B-side components is absolutely critical. It should be noted and highlighted that with reactive chemistries specific principles apply. One of these principles is that with a higher heat the mechanical and physical properties of the next compound will change.

For example, when polyurethanes spray foam is mixed and sprayed at a temperature above that which is optimal for the given foam formulation two things occur: the first is that the foam will expand more than was intended by the formulator, and the second is that with increased expansion the corresponding results of a reduced foam density occurs.

For another example, when high-performance 100% solids coatings are mixed and sprayed at a temperature above that which is optimal for the given coatings formulation three things occur; the first is that the viscosity of the material applied will be lower than the formulator intended and thus affect the flow rates and the output volumetric rates originally designed, the second is that the higher temperature causes a greater reactivity in the polymeric matrix thereby creating a higher cross-link density in the coating film, and the third is that the higher cross-link density of the film will reduce the elongation properties of the film and increase the tensile strength properties of the film.

It can be seen by anyone skilled in the art that increasing the tensile properties of the film, while potentially advantageous at low tensile strength differentials will, at high tensile strength increases most likely create brittleness in the film and thereby cause coating film failure.

Therefore, it can be seen that control of the flow rate, temperature, and mixed rate ratio are all critical factors in a successful application. Due to this, applicators have come to depend upon the application equipment to manage these factors during application. This application will discuss advances in the design of a production of application equipment for plural component chemistries that address and remedy the aforementioned critical factors involved in the successful application of these types of materials.

The majority of highly reactive chemical compositions that are applied using plural component equipment involve formulation that includes an isocyanate monomeric, polymeric, or blend thereof as the side “A”. The side “B” component will be a polyol to yield a polyurethane material, a polyamine to yield a polyurea material, and typically a phenolic to yield an epoxy material. It should be noted that blends of these types of materials are common in the trade. It should be further noted that the convention of referencing the isocyanate components includes the letters ISO and NCO. Lastly, it should be noted that the conventions of referring the isocyanate component as side “A” differ pursuant to geographical regions of the world and also differ pursuant to some of the reactive chemistries.

The use of the term spray gun in this disclosure shall be read to include both spray and extrusion guns and other pieces of equipment that direct the reactive fluid flow towards exiting the fluid lines, either before or after the reactive materials have been mixed. The use of the term spray in this disclosure shall be read to include methods of application of material in the form of spraying or extruding.

There are two main classes of plural component machines that are currently in common use, and both have advantages and disadvantages. The two different major classes of plural component application equipment are the High Pressure Systems (“HPS”) and the Low Pressure Systems (“LPS”). In both of these classes of application equipment there are many potential points of failure, either in design limitations and/or operation. Some potential points of failure in HIPS or LPS systems include Off Ratio—Dual component chemistries can be of varied nature by formulation and by chemical type. Therefore, examples of failures in this discussion will, for the person skilled in the art, be applicable to the area discussed while that person skilled in the art will be able to apply this discussion to the specific chemical composition and application requirements that that specific chemical composition possesses. For example, when spraying any dual-component chemical system the machine system needs to deliver the “A” & “B”-side components to the gun at the manufactures specified volumetric ratio. The volumetric rad is determined by the volume of side “A” divided by the volume of side “B” delivered out of the exit point of the application equipment/gun over a given period of time. Failure to do this will result in “off spec” final product creation and potential installation failure.

There are multiple reasons for Off Ratio (failure) component spraying as follows:

Clogging—This will cause decreased or complete stopping of flow on the “A” or “B” Side, most often on the “A” Side because of the ISO's tendency to crystallize. Once flow is impeded an off ratio condition is created and a bad final product will be produced. This can happen in the transfer pumps, in the screens of the HPS's high pressure pumps, and numerous places within the HPS gun.

Mechanically linked positive displacement pumps of insufficient internal volume, attempt to deliver “A” and “B”-side components of highly different viscosities. The higher viscosity side can be starved of volume flow resulting in a ratio not meeting the “A” and “B”-side components manufacturer's specifications and a failed final product.

When parking the machine for a period of time by allowing the machine to sit idle without any activity, much care must be taken to avoid crystallization of the “A”-Side in the transfer pumps, transfer pump lines, HPS screens, internal application equipment passages, and hose and gun. This can be a labor intensive process. If crystallization occurs, clogging when restarting the system is very likely. Transfer pumps are typically used to transfer the material from bulk storage (typically 55 gallon drums) to the application equipment itself.

To produce high quality foam, constant steady temperatures need to be maintained. Typically electrical heating of the product is performed with drum pre-heaters, machine mounted heater blocks and resistance (through electrical trace lines) heated hoses. Combined these methods can be quite expensive and prone to the natural fluctuations one gets with on-off resistance heaters and their respective controllers. Actuation of the electrical resistance heaters in the heated hoses results in fluctuation of temperatures of the material at the output/gun over time and thus these fluctuations produce variations in final product quality and density as discussed above (not optimum).

All of the above issues, points of failure, and other issues that result in producing inconsistent operating results, are being addressed with the system herein disclosed.

### SUMMARY

To address the issues above, the present application is directed to a system for applying a two component composition. In one embodiment, the system is a pressurized fluid turbulence system comprising a component inlet configured for receiving a liquid component. The component inlet comprises a first cylindrical channel, and is arranged at an upstream position.

A first component outlet is configured for expelling the liquid component received by the component inlet, the first component outlet comprising a second cylindrical channel. The first component output is arranged at a downstream position from the component inlet.

An adjustable ball valve is arranged between the upstream position and the downstream position and in fluid communication with the component inlet and first component outlet. The adjustable ball valve is movable between a closed position and an open position, such that a flow path from the component inlet to the first component outlet is defined through the adjustable ball valve only when the adjustable ball valve is disposed in the open position.

The pressurized fluid turbulence system also includes a pressurized input for receiving a pressurized fluid, the pressurized input having a cylindrical shape. The pressurized input is in fluid communication with the adjustable ball valve, and a longitudinal axis of the pressurized input is aligned in a direction towards the adjustable ball valve such that a pressurized fluid may impact the adjustable ball valve when the pressurized input is in an open position.

The pressurized fluid turbulence system may further include a second component outlet configured for recirculating the liquid component back to the component inlet through a fluid return line when the adjustable ball valve is in the closed position. The fluid return line is arranged between the second component outlet and the component inlet.

In another embodiment, the system also includes a heat exchange system, comprising a heat exchanger that includes a thermally conductive material; a heater reservoir in fluid communication with the heat exchanger; and a heater inside the heater reservoir for heating a heat transfer fluid. The heat exchanger is in fluid communication with a hose, and configured to heat the liquid component with the heat transfer fluid that is heated in the heater reservoir with the heater.

The present application is also directed to a system for mixing two liquid components. In one embodiment, the system comprises a first pressurized fluid turbulence system and a second pressurized fluid turbulence system. Each pressurized fluid turbulence system comprises a component inlet configured for receiving a liquid component, the component inlet comprising a first cylindrical channel. The component inlet is arranged at an upstream position.

Each pressurized fluid turbulence system also comprises a first component outlet configured for expelling the first component received by the component inlet, the first component outlet comprising a second cylindrical channel. The first component outlet is arranged at a downstream position from the component inlet.

An adjustable ball valve is arranged between the upstream position and the downstream position and in fluid communication with the component inlet and first component outlet. The adjustable ball valve is movable between a closed position and an open position, such that a flow path from the component inlet to the first component outlet is defined through the adjustable ball valve only when the adjustable ball valve is disposed in the open position.

The system also may include a pressurized input for receiving a pressurized fluid, the pressurized input having a cylindrical shape. A longitudinal axis of the cylindrical shape is aligned in a direction towards the adjustable ball valve such that a pressurized fluid may impact the adjustable ball valve when the pressurized input is in an open position.

The pressurized input is in fluid communication with the adjustable ball valve. The liquid component in the first pressurized fluid turbulence system is a first liquid component, and the liquid component in the second pressurized fluid turbulence system is a second liquid component. The first component outlet of the first pressurized fluid turbulence system and the first component outlet of the second pressurized fluid turbulence system combine downstream of the first pressurized fluid turbulence system and the second pressurized fluid turbulence system, such that the first liquid component and the second liquid component are mixed together.

In another embodiment, the first pressurized fluid turbulence system further comprises a second component outlet configured for recirculating the first liquid component back to the component inlet through a first fluid return line when the adjustable ball valve of the first pressurized fluid turbulence system is in the closed position. The first fluid return line being arranged between the second component outlet of the first pressurized fluid turbulence system and the component inlet.

The second pressurized fluid turbulence system further comprises a second component outlet configured for recirculating the second liquid component back to the component inlet through a second fluid return line when the adjustable ball valve of the second pressurized fluid turbulence system is in the closed position, the second fluid return line being arranged between the second component outlet of the second pressurized fluid turbulence system and the component inlet.

The system may further include a heat exchange system, comprising a heat exchanger that includes a thermally conductive material; a heater reservoir in fluid communication with the heat exchanger; and a heater inside the heater reservoir for heating a heat transfer fluid. The heat exchanger is in fluid communication with a hose, and configured to heat the first liquid component and the second liquid component with the heat transfer fluid that is heated in the heater reservoir with the heater.

The hose, the first fluid return line, and the second fluid return line may be in direct contact such that the heat transfer fluid can heat the first liquid component and the second liquid component.

The pressurized fluid turbulence system or system for mixing two liquid components may further include a closable valve assembly, the valve assembly comprising an air cylinder; a lever; a shaft connecting the lever and air cylinder; an adjustable valve; and a valve handle for opening and closing the adjustable valve. When the pressurized input is in a pressurized state, the air cylinder activates the lever to prevent the valve handle from movement to prevent operation opening and closing of the adjustable valve.

In some embodiments, the pressurized fluid comprises air, a solvent, or a mixture of air and a solvent. When the pressurized input is closed, fluid does not enter the pressurized input.

In some embodiments, the pressurized input is configured such that when the adjustable ball valve is in the open position, only air can flow through the pressurized input towards the adjustable ball valve and into the component output.

### BRIEF DESCRIPTION OF THE DRAWINGS

FIG. 1 is a cut away view of a pressurized fluid turbulence system according to an embodiment of the present application.

FIG. 2 is a diagram of a heat exchange system according to another embodiment of the present application.

FIG. 3 is a perspective view of a portion of a hose, a first fluid return line, and a second fluid return line according to another embodiment of the present application.

FIG. 4 a diagram showing various portions of a heat exchange system according to another embodiment of the present application.

FIGS. 5A-5B are perspective and overhead views of a closable valve assembly in the locked position and FIGS. 5C-5D are perspective and overhead views of a closable valve assembly in the unlocked position according to another embodiment of the present application.

FIG. 6 is a cut away view of a system for mixing two liquid components according to another embodiment of the present application.

### DETAILED DESCRIPTION

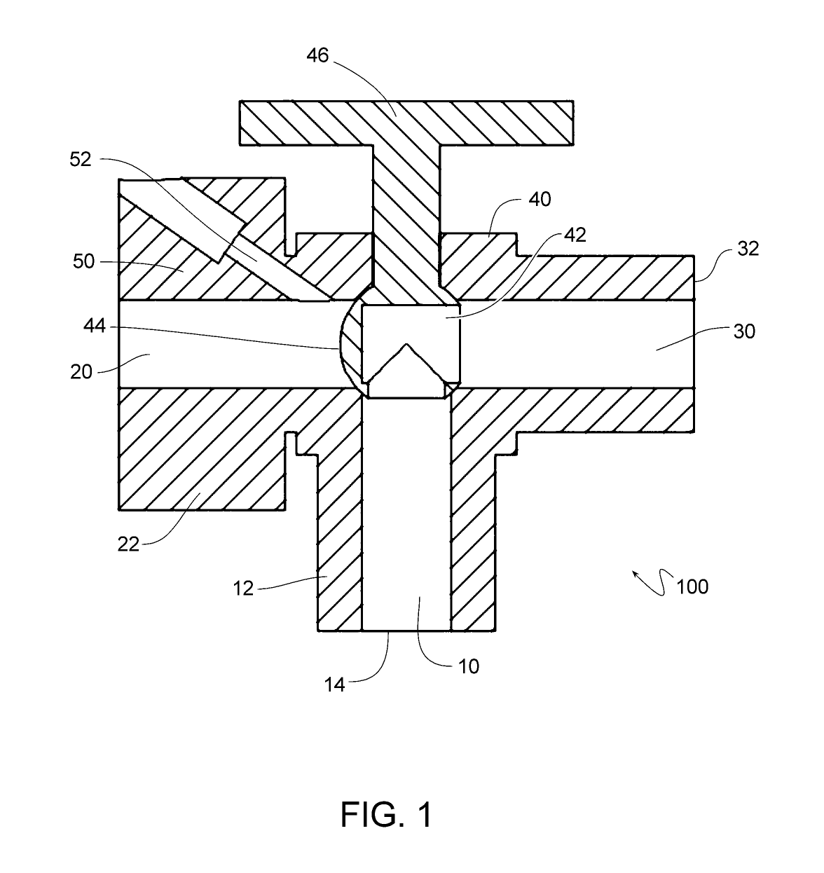

FIG. 1 shows a pressurized fluid turbulence system according to one embodiment of the present application. A component inlet 10 is configured to receive a liquid component. The component inlet 10 includes a first cylindrical channel 12. The component inlet 10 is arranged at an upstream position 14 of the pressurized fluid turbulence system 100.

A first component outlet 20 expels the liquid component received by the component inlet 10. The first component outlet 20 has a second cylindrical channel 22, and is arranged at a downstream position 24 from the component inlet 10.

An adjustable ball valve 40 is located between the upstream position 14 and the downstream position 24 and is in fluid communication with the component inlet 10 and first component outlet 20. The adjustable ball valve 40 is includes a cylindrical port 42, located such that it directs solvent or air at the face 44 of the adjustable ball valve 40. The adjustable ball valve 40 is movable between a closed position and an open position with a handle 46, such that a flow path from the component inlet 10 to the first component outlet 20 is defined through the adjustable ball valve 40 when the adjustable ball valve 40 is disposed in the open position.

The adjustable ball valve 40 can change the direction of the flow of material if it is a 3-way valve. Optionally, the adjustable ball valve 40 can stop the flow of material if it is a 2-way valve.

The pressurized fluid turbulence system 100 can also include a second component outlet 30 that recirculates the liquid component back to the component inlet 10 through a fluid return line 82 when using a 3-way adjustable ball valve 40 is in the closed position. The second component outlet 30 includes a third cylindrical channel 32.

When material flow is redirected into a closed loop system using 3-way adjustable ball valve—via a fluid return line 82, or stopped when using a 2-way adjustable ball valve, the section of adjustable ball valve 40 exposed to atmosphere still has extra material on it. In the case of reactive materials, the extra material will cure/harden/gel and cause a clogged/blocked first component output 20. Thus, the present application may include a pressurized, input 50 for receiving a pressurized fluid, the pressurized, input 50 may have a cylindrical shape,

The pressurized input 50 is in fluid communication with the adjustable ball valve 40, and a longitudinal axis 52 of the pressurized input 50 is aligned in a direction towards the adjustable ball valve 40 such that a pressurized fluid may impact the adjustable ball valve 40 when the pressurized input is in an open position. A strew of solvent or air to blast/purge the exposed face 44 of the adjustable ball valve 44 to clean it thoroughly of any foreign material.

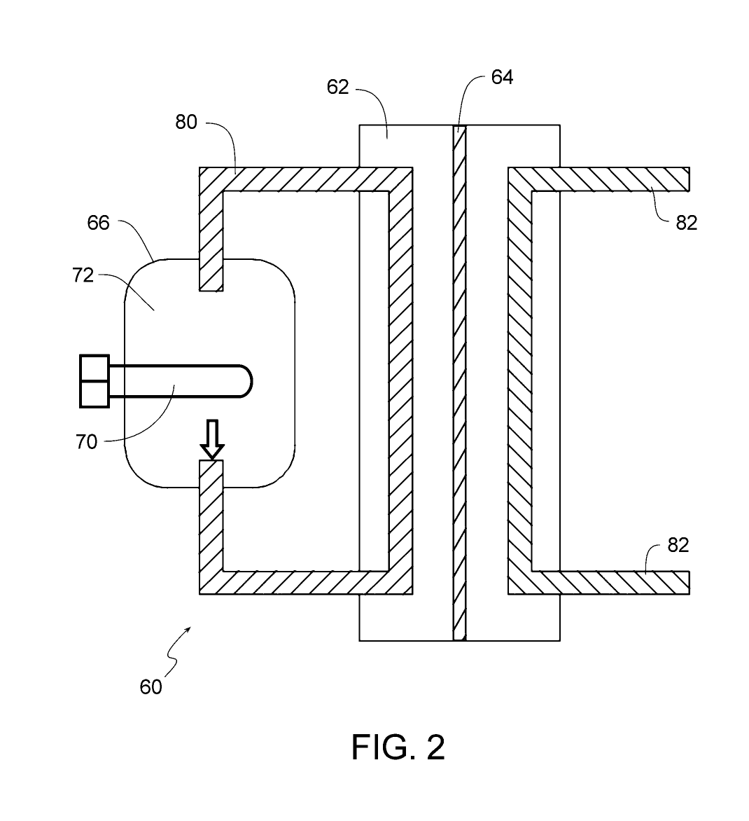

FIG. 2 shows a heat exchange system 60 for maintaining a constant temperature and viscosity of the components in the system. The heat exchange system 60 includes a heat exchanger 62 that includes a thermally conductive material 64. A heater reservoir 66 is in fluid communication with the heat exchanger 62. A heater 70 is arranged inside the heater reservoir 66 for heating a heat transfer fluid 72.

The heat exchanger 62 is in fluid communication with a hose 80, and heats the liquid component with the heat transfer fluid 72 that is heated in the heater reservoir 66 with the heater 70. The heater fluid flows through a path that flows through the heat exchanger 62 and the heater reservoir 66.

The heat exchanger 62 may be any means of housing a thermally conductive material 64, on either side of which heat transfer fluid 72 can come into contact with the thermally conductive material 64. The thermally conductive material 64 may be any material that transfers energy in the form of heat from the heat transfer fluid 72 to the material fluid, such as the liquid component in the fluid return line 82.

The heat transfer fluid 72 receives heat energy from a heater 70. The heat transfer fluid 72 is propelled or cycled through a flow path that allows it to enter and exit the heat exchanger 62. When coming in contact with the thermally conductive material 64 housed inside the heat exchanger 62, the heat energy is transferred to the thermally conductive material 64.

The liquid component is propelled/cycled through fluid return line 82 such that it enters and exits the heat exchanger 62. The liquid component, upon contact with the thermally conductive material 64, housed inside the heat exchanger 62, receives prior transferred heat energy from the thermally conductive material 64, such that the liquid component exits the heat exchanger 62 containing more heat energy than when it entered.

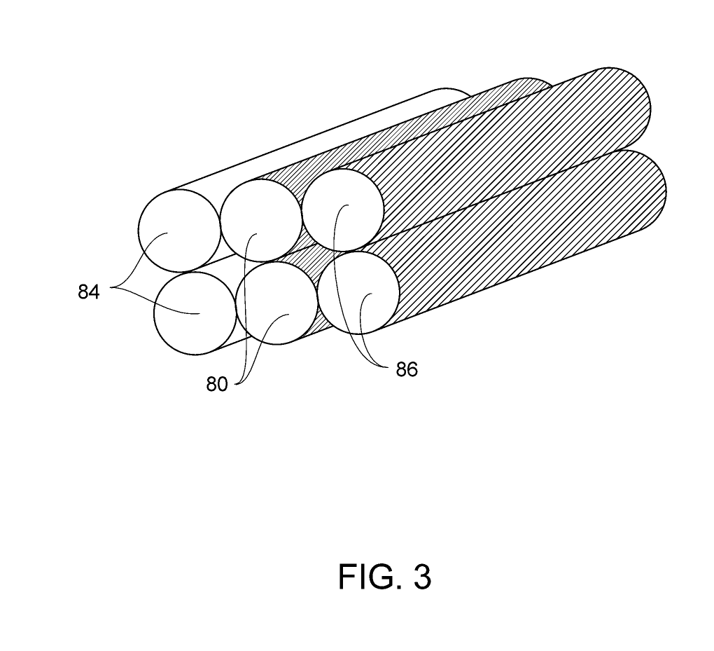

FIG. 3 shows a secondary heat transfer mechanism, in which the hose 80, a first fluid return line 84, and a second fluid return line 86 are in direct contact. This allows for the heat transfer fluid 72 to heat the first liquid component and the second liquid component. In this figure, the assembly shows both the outgoing and returning portions of the hose 80, a first fluid return line 84, and a second fluid return line 86 in direct contact with each other.

The first fluid return line 84 could be for an “A” side, and the second fluid return line 86 could be for a “B” side. A sub-section of a hose assembly/bundle which may be used in foam/coatings applications is used to carry foam/coatings fluid from a pumping mechanism/machine to a spray/extrude application “gun” for user-control of application, with the addition of fluid paths for a heat transfer fluid 72. By passing a heated transfer fluid 72 in close proximity to first and second fluid return lines 84, 86, the heat transfer fluid 72 heats the liquid components, such as foam/coatings material. The entire assembly may be wrapped in an insulation layer (not shown).

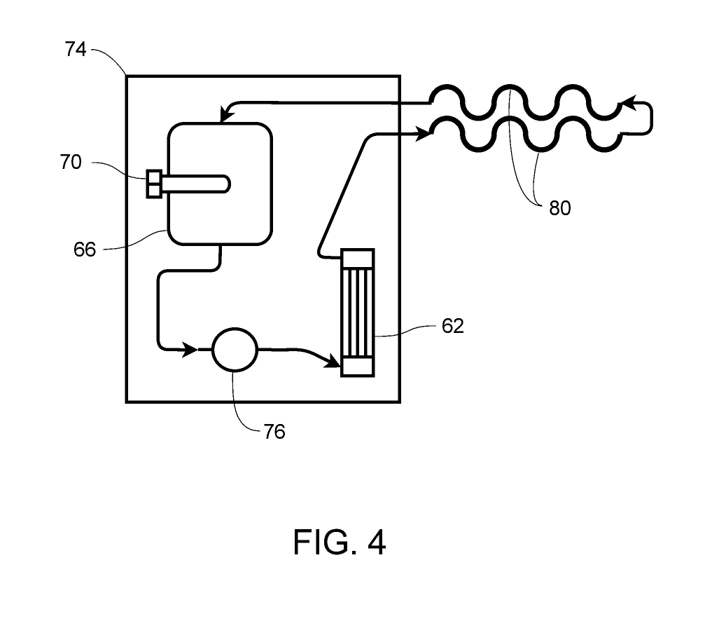

FIG. 4 shows the circulation path of a heat transfer fluid 72 throughout the heat exchange system 60. Heat transfer fluid 72 is heated by an electric heater 70, and propelled though the system with a fluid circulation pump 76.

The fluid return line 82 carries the liquid component to a spray/extrude application “gun” and heated by the heat transfer fluid 72 while carried. A fluid circulation pump 76 pumps the heat transfer fluid 72 through the entire system. This figure shows the circulation and re-circulation of the heat transfer fluid 72 throughout the entirety of the collective heat exchange system 60.

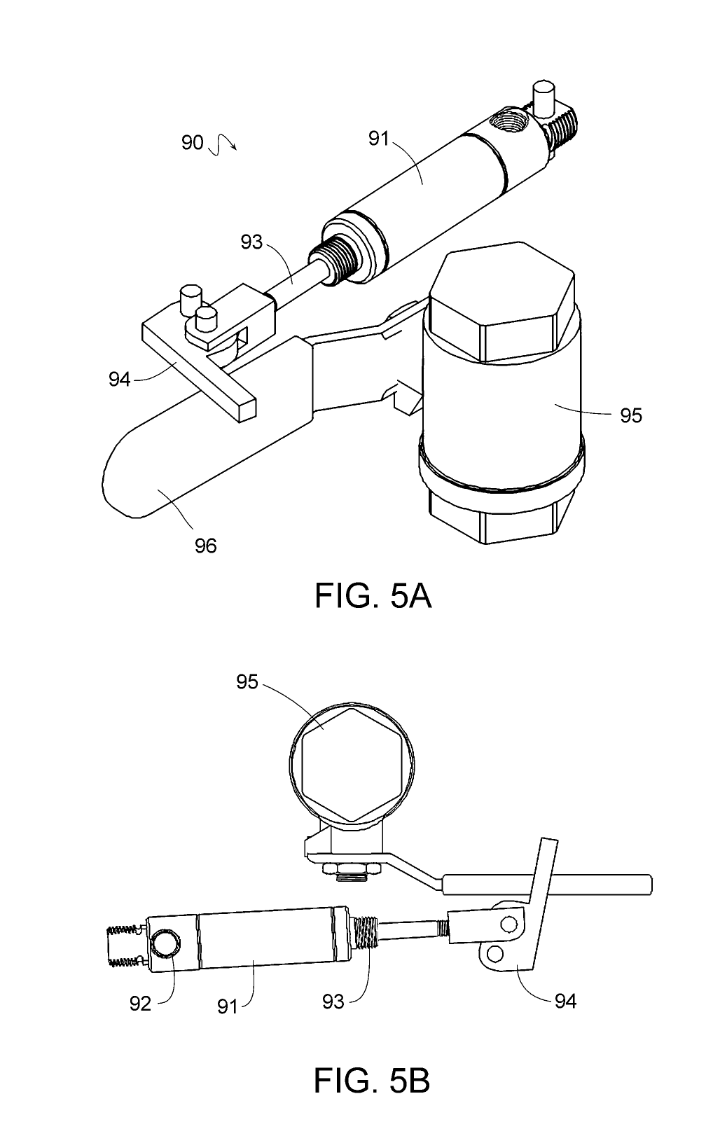

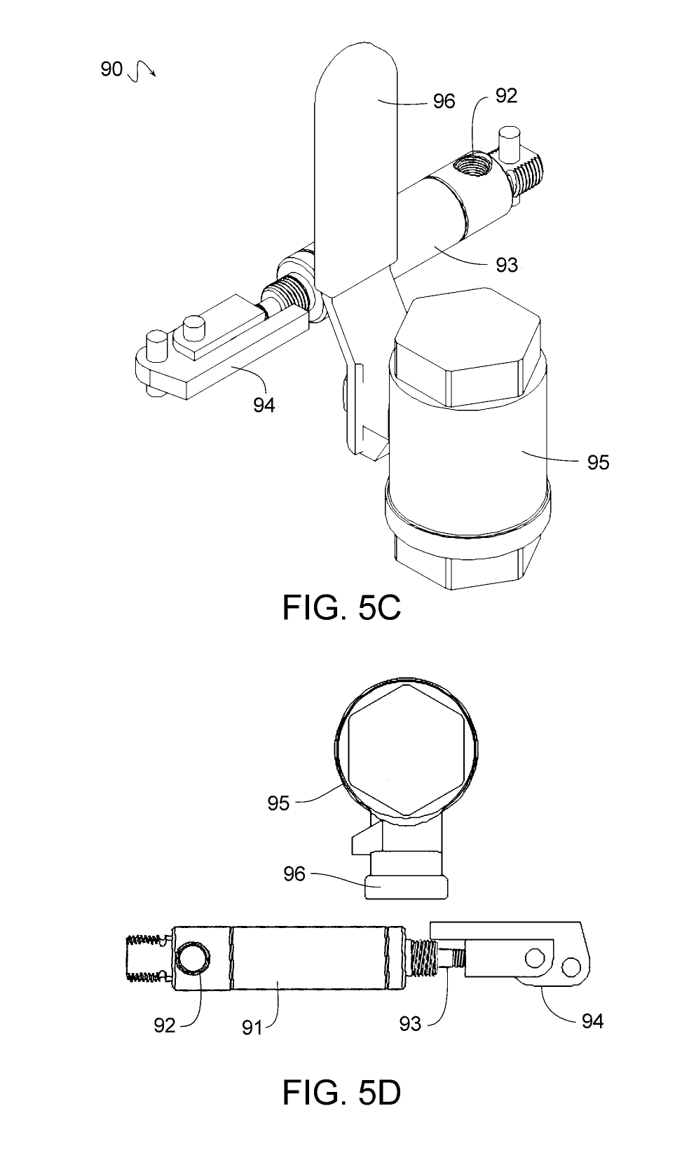

FIGS. 5A-D show a closable valve assembly that includes an air cylinder 91 that actuates or moves a rod shaft 93 based on air pressure delivered to air pressure input 92. The air pressure input is a connection for a compressed air input.

The shaft 93 slides in and out of air cylinder 91 based on air pressure input. A lever 94, or mechanical lockout bracket interferes with the operation of the ball valve handle 96 when the shaft 93 is extended. The adjustable ball valve 95 controls flow of a liquid or vapor based on its open or closed position by actuating the adjustable ball valve 95 to allow or block the flow of liquid or vapor. The adjustable ball valve 40 is used in other embodiments as this as well.

FIGS. 5A-B shows the closable valve assembly or safety interlock system as “on” or “engaged” and the pressurized storage vessel is closed. FIGS. 5C-D show the closable valve assembly or safety interlock system as “off” or “disengaged” and the pressurized storage vessel open. The fluid flush systems' solvent storage tank gets pressurized by the same compressed air supply that activates the mixing in the gun, and activates the valve handle lock described below.

The closable valve assembly 90 or safety interlock system is designed as a safety device to prevent the accidental or intentional discharge of a pressurized fluid or vapor. The same pressure that is applied to the fluid/vapor vessel closed off by the adjustable ball valve 95 is applied to the air cylinder 91 via the air pressure input 92. If the adjustable ball valve 95 is open when pressure is applied, the pressure will leak out of the adjustable ball valve 95 causing no pressure increase in the system.

If the adjustable ball valve 95 is closed when pressure is applied to the system, pressure will be held by the system and increase to match the source pressure. When pressure in the system increases, the shaft 93 extends outward from the air cylinder 91 and rotates or pivots the lever 94 or mechanical lockout bracket. When rotated or pivoted, the lever or mechanical lockout bracket 94 physically blocks the valve handle 96 from being rotated, therefore blocking the adjustable ball valve 95 from being opened releasing pressurized fluid/vapor.

Upon system de-pressurization, a spring (not shown) located inside the air cylinder 91 pulls the shaft 93 back into the air cylinder 91 body. This returns the lever 94 or mechanical lockout bracket to an “off” position allowing a user to safely open the adjustable ball valve 95. This method guarantees that no one can accidentally or intentionally open the vessel when pressurized and protects against the release of pressurized air and solvent. This invention assures operator safety in an industry where operator injury is frequently caused by unprotected exposure to reactive and caustic materials.

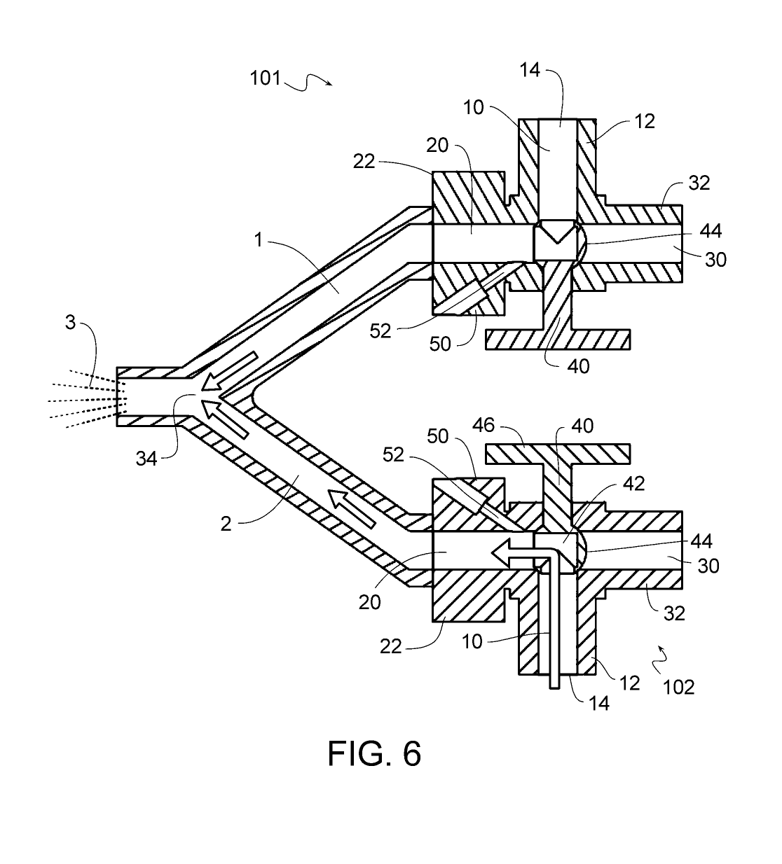

FIG. 6 shows a system for mixing two liquid components. The system uses two pressurized fluid turbulence systems to mix two liquid components. The mechanism of operation of the two pressurized fluid turbulence systems 101, 102 are equal, and explained above.

Defining the liquid component in the first pressurized fluid turbulence system as a first liquid component 1, and the liquid component in the second pressurized fluid turbulence system as a second liquid component 2, the first component outlet 20 of the first pressurized fluid turbulence system and the first component outlet 20 of the second pressurized fluid turbulence system combine downstream 34 of the first pressurized fluid turbulence system 101 and the second pressurized fluid turbulence system 102, such that the first liquid component 1 and the second liquid component 2 are mixed together to form a mixed component 3, which can then be transmitted out through a nozzle of a spray gun.

This system may be classified as a variable pressure system, in that it can be operated as a low pressure system operating at a hose pressure of less than 250 psi but it can also be operated as a medium/high pressure system operating at a hose pressure above 250 psi.

There are valves in a spray gun that are linked together to synchronize the redirecting of the “A” & “B”-side components, from recirculation mode to spray mode. Since the system is constantly recirculating when not spraying, the gun has the “A” & “B”-side components at optimum temperature, ready for application. This eliminates the stagnant and otherwise unheated material that will form whenever the flow valves of a conventional (non-recirculating) system are not in the spraying mode.

The system has a dual function injection orifice in both the “A” & “B”-side fluid pathways. The function of either side is identical. The orifice is in close proximity to the face of the valve's downstream/output side and points at it. When in spray mode, the orifice is presenting a stream of compressed air to the component fluid stream via the pressurized input 50. The compressed air can be turned off to extrude instead of spray. This air enters the stream opposite of its flow direction. As the stream of “A” or “B”-side component is “injected” with a narrow stream of high pressure air it becomes turbulent to a very high level. As these very turbulent streams of “A” & “B”-side component exit the gun block into the mixing tip downstream 34 of the first pressurized fluid turbulence system 101 and the second pressurized fluid turbulence system 102, they violently interact and mix and are propelled from the tip of the gun in a controlled stream of thoroughly mixed “A” & “B”-side components 3.

When the operator pulls the adjustable ball valve handle 46 back to the off-position, the valves 40 redirect the “A” & “B”-side components back to the fluid return lines 84, 86. Residual materials in the pathways are ejected through the front of the gun by the high pressure air stream. This ejection process is substantial but not complete. The operator can now direct, with the switching of another air/flush valve, a short blast of pressurized solvent into the pressurized input 50. This solvent enters the stream 20 through the same pressurized input 50. The solvent will directly impact the face 44 of the adjustable ball valves 40, completely sweeping them free, the operator will then switch back to air and the air blast will finish the cleaning process.

By cleaning the face of the adjustable ball valve 40 that is in the spray gun, crystals and reactive materials that otherwise form into pre-polymeric matrixes or actual polymeric matrices are prevented from forming and thus ever entering into the fluid stream which would otherwise compromise the quality of the chemical system compound and/or potentially cause mechanical damage.

The “A” & “B”-side component fluid supply pumps are variable speed, positive displacement types, fully speed adjustable-13 facilitating proper adjustment of the desired ratio. For current spray foam the desired ratio is 1:1. Conventional systems may use other ratios. The present application uses a machine that is completely variable and capable of delivering any ratio desired. By having adjustable speed pumps the system is able to adjust to “A” & “B”-side components that may be of such different viscosities that having the pumps locked together (as is the case in the standard dual-component spray pump systems) prevents the system from delivering actual 1:1 ratio “A” & “B”-side components to the gun.

This application unleashes the chemical formulator's options to bring properties into a reactive chemical material product since the formulator does not have to compromise the properties of the formulation to conform to the industry standard 1:1 fixed ratio and direct fluid pump style equipment.

The present application allows for a low-cost of operation, maintenance and repair of equipment. The two component equipment most commonly utilized in the industries discussed herein comprise parts and hardware that are custom tool or formed for the purpose of creating post sale replacement part markets.

1. A pressurized fluid turbulence system comprising:
a component inlet configured for receiving a liquid component, the component inlet comprising a first cylindrical channel, wherein the component inlet is arranged at an upstream position;
a first component outlet configured for expelling the liquid component received by the component inlet, the first component outlet comprising a second cylindrical channel, the first component output arranged at a downstream position from the component inlet;
an adjustable ball valve arranged between the upstream position and the downstream position and in fluid communication with the component inlet and first component outlet;
wherein the adjustable ball valve is movable between a closed position and an open position, such that a flow path from the component inlet to the first component outlet is defined through the adjustable ball valve only when the adjustable ball valve is disposed in the open position; and
a pressurized input for receiving a pressurized fluid, the pressurized input having a cylindrical shape,
wherein the pressurized input is in fluid communication with the adjustable ball valve, and
wherein a longitudinal axis of the pressurized input is aligned in a direction towards the adjustable ball valve such that a pressurized fluid may impact the adjustable ball valve when the pressurized input is in an open position.

2. The pressurized fluid turbulence system of claim 1, further comprising:
a second component outlet configured for recirculating the liquid component back to the component inlet through a fluid return line when the adjustable ball valve is in the closed position, the second component outlet comprising a third cylindrical channel, and
wherein the fluid return line is arranged between the second component outlet and the component inlet.

3. The pressurized fluid turbulence system of claim 2, further comprising:
a heat exchange system, comprising:
a heat exchanger comprising a thermally conductive material;
a heater reservoir in fluid communication with the heat exchanger; and
a heater inside the heater reservoir for heating a heat transfer fluid,
wherein the heat exchanger is in fluid communication with a hose, and configured to heat the liquid component with the heat transfer fluid that is heated in the heater reservoir with the heater.

4. A system for mixing two liquid components, comprising:
a first pressurized fluid turbulence system and a second pressurized fluid turbulence system, each pressurized fluid turbulence system comprising:
a component inlet configured for receiving a liquid component, the component inlet comprising a first cylindrical channel, wherein the component inlet is arranged at an upstream position;
a first component outlet configured for expelling the liquid component received by the component inlet, the first component outlet comprising a second cylindrical channel, the first component outlet arranged at a downstream position from the component inlet;
an adjustable ball valve between the upstream position and the downstream position and in fluid communication with the component inlet and first component outlet;
wherein the adjustable ball valve movable between a closed position and an open position, such that a flow path from the component inlet to the first component outlet is defined through the adjustable ball valve only when the adjustable ball valve is disposed in the open position; and
a pressurized input for receiving a pressurized fluid, the pressurized input having a cylindrical shape,
wherein a longitudinal axis of the cylindrical shape is aligned in a direction towards the adjustable ball valve such that a pressurized fluid may impact the adjustable ball valve when the pressurized input is in are open position,
wherein the pressurized input is in fluid communication with the adjustable ball valve,
wherein the liquid component in the first pressurized fluid turbulence system is a first liquid component, and the liquid component in the second pressurized fluid turbulence system is a second liquid component, and
wherein the first component outlet of the first pressurized fluid turbulence stem and the first component outlet of the second pressurized fluid turbulence system combine downstream of the first pressurized fluid turbulence system and the second pressurized fluid turbulence system, such that the first liquid component and the second liquid component are mixed together.

5. The system of claim 4,
wherein the first pressurized fluid turbulence system further comprises a second component outlet configured for recirculating the first liquid component back to the component inlet through a first fluid return line when the adjustable ball valve of the first pressurized fluid turbulence system is in the closed position, the second component outlet comprising a third cylindrical channel, and the first fluid return line being arranged between the second component outlet of the first pressurized fluid turbulence system and the component inlet,
wherein the second pressurized fluid turbulence system further comprises a second component outlet configured for recirculating the second liquid component back to the component inlet through a second fluid return line when the adjustable ball valve of the second pressurized fluid turbulence system is in the closed position, the second component outlet comprising a third cylindrical channel, the second fluid return line being arranged between the second component outlet of the second pressurized fluid turbulence system and the component inlet.

6. The system of claim 5, further comprising:
a heat exchange system, comprising:
a heat exchanger comprising a thermally conductive material;
a heater reservoir in fluid communication with the heat exchanger; and
a heater inside the heater reservoir for heating a heat transfer fluid,
wherein the heat exchanger is in fluid communication with a hose, and configured to heat the first liquid component and the second liquid component with the heat transfer fluid that is heated in the heater reservoir with the heater.

7. The system of claim 6,
wherein the hose, the first fluid return line, and the second fluid return line are in direct contact such that the heat transfer fluid can heat the first liquid component and the second liquid component.

8. The pressurized fluid turbulence system of claim 1,
wherein the pressurized input further comprises a closable valve assembly, the valve assembly comprising:
an air cylinder;
a lever;
a shaft connecting the lever and air cylinder;
an adjustable valve; and
a valve handle for opening and closing the adjustable valve, wherein,
when the pressurized input is in a pressurized state, the air cylinder activates the lever to prevent the valve handle from movement to prevent operation opening and closing of the adjustable valve.

9. The pressurized fluid turbulence system of claim 1, wherein the pressurized fluid comprises air, a solvent, or a mixture of both.

10. The pressurized fluid turbulence system of claim 1, wherein when the pressurized input is closed, fluid does not enter the pressurized input.

11. The pressurized fluid turbulence system of claim 1, wherein the pressurized input is configured such that when the adjustable ball valve is in the open position, either air or nothing can flow through the pressurized input towards the adjustable ball valve and into the component output.
